(19) United States
(12) Patent Application Publication
(10) Pub. No.: US 2013/0152466 A1
(43) Pub. Date: Jun. 20, 2013

(54) CONVERTIBLE PLANTING CONTAINERS

(71) Applicants: James M. Hillson, Goffstown, NH (US); Mohit Gidwani, Watertown, MA (US); Mary L. Watts, Warner, NH (US); Derrick Slowikowski, Merrimack, NH (US)

(72) Inventors: James M. Hillson, Goffstown, NH (US); Mohit Gidwani, Watertown, MA (US); Mary L. Watts, Warner, NH (US); Derrick Slowikowski, Merrimack, NH (US)

(73) Assignee: VELCRO INDUSTRIES B.V.

(21) Appl. No.: 13/328,308

(22) Filed: Dec. 16, 2011

(51) Int. Cl. A01G 9/02; B65B 3/04

(52) U.S. Cl. 47/65.7; 53/452; 47/66.7

(57) ABSTRACT

A convertible planting system includes a flexible sheet of material bent into an overlapped configuration to form a container defining an interior volume, the flexible sheet having a first broad surface covered with an engageable loop material, and a second broad surface from which touch fastener hooks extend in an area overlapping the first broad surface with the sheet of material bent to form the container; with the hooks releasably engaged with the loop material, and soil filling at least a portion of the interior volume of the container and in contact with the loop material. A gardener may plant a seed in the convertible planting system, peel back a portion of the sheet of material forming a wall of the container by releasably disengaging hooks and loops of the sheet of material, and reattach the portion of the sheet of material by reengaging the hooks and loops.

### TECHNICAL FIELD

This invention relates to the structure, manufacture, assembly and use of reusable potting containers for seedling growth.

### BACKGROUND

Disposable containers are often used for initiating and promoting plant growth. Initiating plant growth may begin with placing a mixture of soil and seedlings within a disposable or other type of container to form a plant system. Seedling germination subsequently occurs within the container. In some instances, the container is biodegradable, allowing the plant system to be planted directly within an outdoor soil mass for prolonged growth. In other cases, the container is non-biodegradable, and the plant system is placed atop a capillary mat in an indoor environment to promote germination at a controlled rate and/or to protect the plant system from garden animals. In such cases, gardeners often desire to inspect root growth within the soil to determine the health and maturity of the plant. In some examples, once the plant appears to have attained a desired maturity, the plant and soil are removed from the container by flipping the container over to release the plant and soil, which are then planted in an outdoor soil mass for further growth. During the release and replanting of the plant and soil, the roots may be damaged, which can detrimentally affect the health of the plant.

### SUMMARY

The invention involves a realization that certain attributes of a potting container can provide easy access to a plant seeded within the potting container, and removing the plant for transplanting, without damaging the plant, and that such attributes may be provided by a potting container fashionable from a flexible sheet of material featuring touch fastening surfaces.

One aspect of the invention features a method of preparing a container for planting. The method includes bending a flexible sheet of material into an overlapped configuration to form a container defining an interior volume for holding soil. The flexible sheet has a first broad surface covered with an engageable loop material exposed over at least half of an interior surface area of the container, and a second broad surface from which touch fastener hooks extend in an area overlapping the first broad surface with the sheet of material folded to form the container, with the touch fastener hooks releasably engaged with the engageable loop material. The method also includes placing the soil in the interior volume of the container, in contact with the loop material.

By “hooks” we mean male touch fastener elements configured to be releasably engageable with a fibrous surface to form a peelable fastening. Such hooks may be molded or formed by other means, and may be in the form of headed stems.

In some implementations, the touch fastener hooks extend in an array covering a majority of an outer surface area of the container.

In some examples, the loop material essentially covers the interior surface area of the container.

In some cases, the loop material is a knit or non-woven material.

In some instances, the loop material has a basis weight of between 40 and 400 grams per square meter.

In some implementations, the loop material comprises hydroscopic fibers, such as nylon fibers.

In some examples, the second broad surface is disposed on an outer surface of the container.

In some cases, both the first and second broad surfaces are disposed on an inner surface of the formed container.

In some instances, the flexible sheet of material comprises a continuous sheet of resin from which the touch fastener hooks extend on the second broad surface, the sheet of resin and stems of the touch fastener hooks together forming a contiguous mass of resin.

Such a resin sheet and fastener hooks may be formed by a continuous roll-molding process, such as taught in U.S. Pat. No. 4,775,310 to Fischer, the entire contents of which are hereby incorporated by reference.

In some implementations, the loop material and the continuous sheet of resin form a laminate in which some fibers of the loop material are at least partially embedded in the continuous sheet of resin, with other fibers exposed for engagement.

In some examples, as bent, the flexible sheet forms the container having a base and defining a plant growth opening opposite the base, the plant growth opening being smaller than the base. In some cases the walls of the container slope inward toward the opening, giving the container a somewhat frustoconical or pyramidal shape that increases stability against tipping.

In some cases, an outer surface of the base is covered by an array of the touch fastener hooks.

In some instances, the flexible sheet of material is shaped to define flaps extending from a central portion of the sheet of material, and bending the flexible sheet of material includes bending the flaps to form respective sides of the container.

In some implementations, the flexible sheet of material, prior to bending, defines slits that form drainage apertures through walls of the container.

In some examples, the method further includes, prior to bending the flexible sheet of material, overlapping two separate flexible pieces of material to form the flexible sheet of material, the two pieces of material each having a loop material on one side and a field of engageable fastener hooks on the other side, such that the hooks of one of the two pieces releasably engage loops of the other of the two pieces.

In some cases, each of the pieces of material forms a pair of oppositely-directed flaps of the flexible sheet of material.

In some instances, the container as formed has a first wall with an interior surface covered with loops, and an adjacent wall with an interior surface covered with touch fastener hooks and releasably secured to the first wall by overlapping wall tabs extending outward from the container between the first and adjacent walls.

In some implementations, the method further features forming multiple container portions, each defining a respective interior planting volume, one of the container portions having an outer surface carrying exposed touch fastener hooks, and another of the container portions having an outer surface covered with an engageable loop material, and then releasably engaging the container portions to form a connected container defining multiple planting volumes.

In some examples, the method further includes overlapping and releasably attaching a container extension about a rim of the container formed by the sheet of material, thereby increasing a planting volume of the container.

In some cases, the method further involves attaching a handle spanning opposite edges of the container adjacent an opening of the container, the handle being formed of a strip of flexible material having engageable loops that releasably engage hooks of the flexible sheet of material.

In some implementations, the details of any of the above-described features can be implemented in accordance with any of the aspects of the invention discussed below.

Another aspect of the invention features a convertible planting system that includes a flexible sheet of material bent into an overlapped configuration to form a container defining an interior volume. The flexible sheet has a first broad surface covered with an engageable loop material exposed over at least half of an interior surface area of the container, and a second broad surface from which touch fastener hooks extend in an area overlapping the first broad surface with the sheet of material bent to form the container, with the hooks releasably engaged with the loop material. The system also includes soil that fills at least a portion of the interior volume of the container, in contact with the loop material.

Another aspect of the invention features a method of preparing a seedling for transplant. The method includes planting a seed in the convertible planting system described herein, growing a seedling from the seed, such that roots of the seedling contact the engageable loop material of the interior surface of the container, peeling back a portion of the sheet of material forming a wall of the container by releasably disengaging hooks and loops of the sheet of material, to expose the soil and an adjacent root of the seedling, and then reattaching the portion of the sheet of material by reengaging the hooks and loops that were disengaged.

Another aspect of the invention features a planting container package. The planting container package includes one or more flexible sheets of material, each having a first broad surface covered with an engageable loop material, and a second broad surface covered with an array of touch fastener hooks. Each flexible sheet also has a perimeter shape configured to facilitate folding of each flexible sheet to form a planting container defining an interior volume for holding soil, with the engageable loop material exposed over at least half of an interior surface area of the planting container, and the hooks releasably engaged with the loop material to hold a shape of the planting container. The planting container package also includes packaging that includes the one or more flexible sheets of material. The packaging features instructions for folding the one or more sheets of material to form planting containers.

Various embodiments of the convertible container may thus provide various advantages. For example, roots may grow from a seedling planted within the container to contact a fibrous inner surface of the container that also serves as an engagement surface to hold the container in its shape. Such root contact may promote lateral growth and extension of another root from a stem of the contacting root, and reduce the tendency of roots to wrap around the inner container walls. In some examples, such lateral root extension can minimize transplant shock to the seedling and roots.

Many examples enable inspection of the growing root system by detaching one or more of the container walls and folding down the one or more container walls towards the base, to expose the soil and the roots, while allowing the container walls to be reattached after inspection. In some examples, folding down the one or more container walls to access the seedling and the soil can allow easy access to the seedling and the soil without tipping over the container to release the soil, and thus reduce the risk of damaging the roots. Upon removing the seedling and the soil from the container, the container may be reused for potting another seedling.

In some instances, the plant system may be easily transported while the seedling and the soil remain within the container. The fastening surface on an underside of the base may permit the container to be releasably engaged with a fibrous surface supporting the container. Holes or slits through the base, side walls, or top walls of the container can be provided to allow for fluid migration from or into the soil or for access to deliver growth medium to the seedling and the soil.

The soil cavity defined by the assembled container can be configured to provide increased soil capacity relative to some alternative potting containers. In some cases, the detachable feature of the container walls can permit planting of multiple seedlings having differing growth rates within the same container.

Configuring the container to be disassemblable into a flat configuration between uses can conserve packaging and shipping space and provide packaging flexibility, thus providing relatively low shipping and handling costs.

The details of one or more embodiments of the invention are set forth in the accompanying drawings and the description below. Other features, aspects, and advantages of the invention will be apparent from the description, drawings, and claims.

### BRIEF DESCRIPTION OF THE DRAWINGS

FIG. 1 is a top view of a planting container preform in the form of a flat sheet.

FIG. 2 is a side view of the planting container preform of FIG. 1.

FIG. 3 is a perspective view of the planting container preform of FIG. 1, folded into a container having a stable, rectangular shape.

FIG. 4 is a perspective view of the container of FIG. 3, with one wall partially detached for access.

FIG. 5 is a perspective view of the container of FIG. 3, releasably attached to a fibrous wall.

FIG. 6 is a perspective view of the planting container preform of FIG. 1, folded into a stable, non-rectangular shape.

FIG. 7 is perspective view of a stack of the planting container preform of FIG. 1.

FIG. 8 is a top view of a die-cut flat sheet configured to form part of a foldable container preform.

FIG. 9 shows two of the sheets of FIG. 8, overlapped in a cross pattern to form a planting container preform similar to that of FIG. 1.

FIG. 10 is a perspective view of the planting container preform of FIG. 9, folded into a container having a stable, rectangular shape and accessorized with features that provide convenience for its use.

FIG. 11 is a perspective view of a stacked foldable container formed from the sheets of FIG. 8.

FIG. 12 is a set of laterally attached containers formed from the planting container preform of FIG. 9.

FIG. 13 is a perspective view of a bottom-openable planting container preform folded into a container having a stable, elongate shape.

Like reference symbols in the various figures indicate like elements.

### DETAILED DESCRIPTION

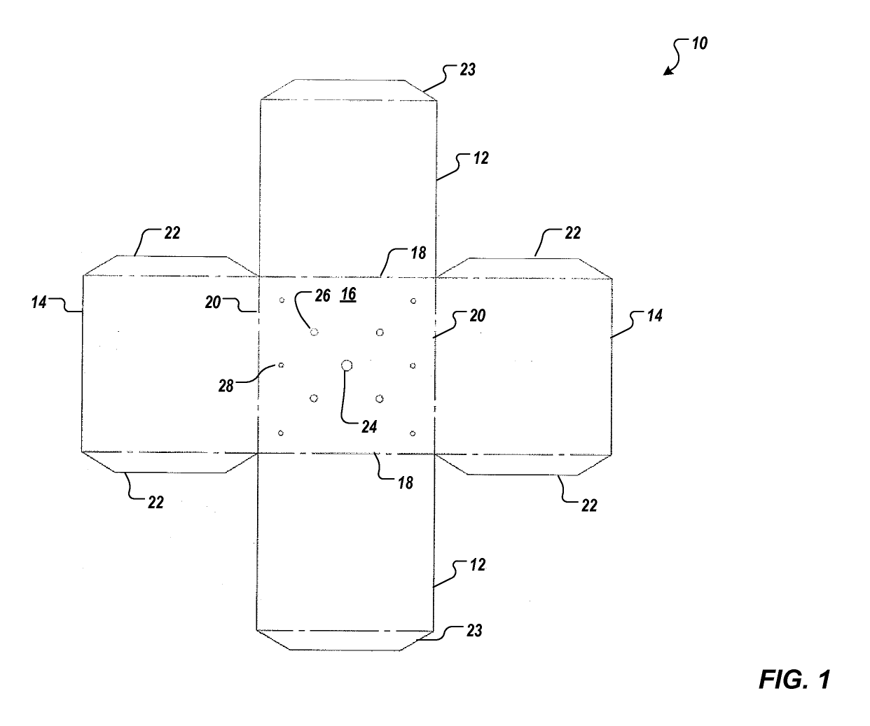

Referring first to FIG. 1, a planting container preform 10 in the form of a plastic sheet includes two spaced apart, laterally tabbed walls 12 and two spaced apart, longitudinally tabbed walls 14 that extend from a common base 16. In the example of FIG. 1, container preform 10 is illustrated in a disassembled, open configuration. Walls 12 are foldable along spaced apart edges 18 of base 16, and tabbed walls 14 are foldable along spaced apart edges 20 of base 16. Edges 18 extend perpendicular to edges 20, such that walls 12 and tabbed walls 14 can be folded upward along edges 18 and edges 20, respectively, and adhered to adjacent walls 12, 14 to form a substantially closed wall extending from base 16. Tabs 22 extend laterally from each side of walls 14 and past edges 18, thus extending vertically from base 16 when walls 14 are folded upward along edges 20. Tabs 22 are further foldable upon walls 14. Tabs 23 extend longitudinally from each end of walls 12 and are foldable upon walls 12.

By “foldable” or “folded” we do not mean to imply that a sharp bend or crease is necessary. Bending may involve only flexing the material from a flat to a curved condition in which the material remains under elastic bending stresses and is held in its container shape by fastening forces.

A center hole 24 is located at a center of base 16, and spaced apart holes 26, 28 within base 16 surround center hole 24. Center hole 24 has a diameter larger than that of holes 26, 28, and holes 26 have a diameter larger than that of holes 28.

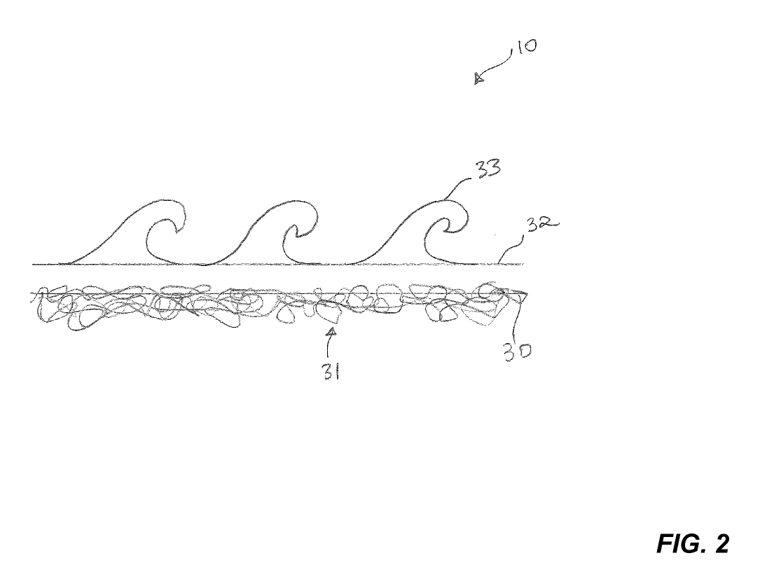

As shown in FIG. 2, planting container preform 10 is formed from a thin, flexible sheet having an engageable surface 30 and a fastening surface 32 opposite engageable surface 30. The engageable surface is substantially covered with a looped material 31, such as a non-woven or lightweight knit, that is compatible with miniature touch fastening elements 33, such as hooks, extending from and distributed across fastening surface 32. In some instances, looped material 31 has a basis weight of 40-400 grams per square meter. The hooks generally may be any of several male touch fastener shapes, such as J hooks, mushroom hooks, and palm tree hooks, among others. Such a sheet can be manufactured as a laminate in a continuous roll-molding process, such as is taught in U.S. Pat. No. 5,260,015, the entire contents of which are incorporated here by reference. In such a laminate the loop material may be directly and intimately embedded in resin forming the base from which the fastener hooks extend. After the molding and lamination, the material having a hook side and a cooperative loop side may be readily die cut into the various shapes shown herein. In some cases, a sheet having an engageable surface may be attached to another sheet having a fastening surface, forming one sheet having an outer engageable surface and an outer fastening surface.

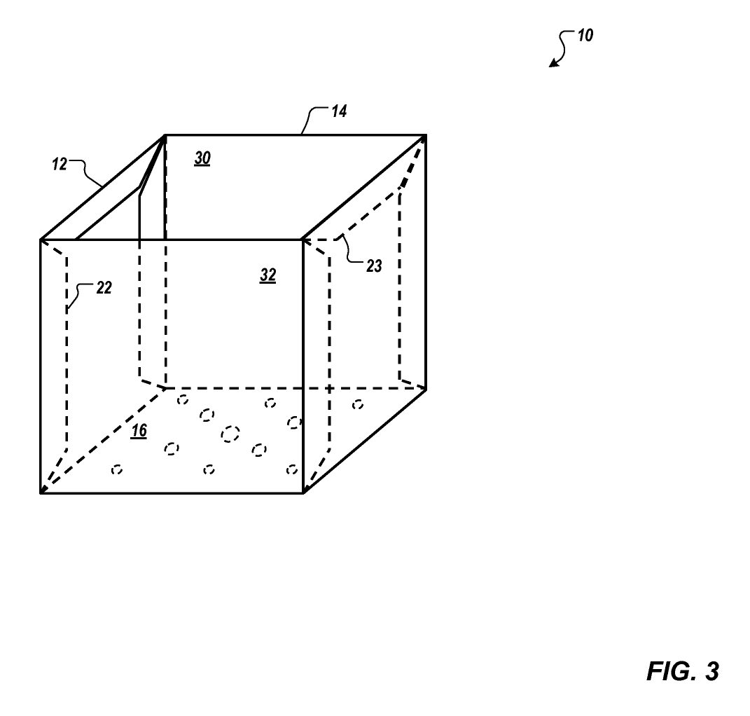

FIG. 3 displays an example view of planting container preform 10 folded in an assembled configuration. Walls 12, 14 extend upward from base 16 and are releasably attached to adjacent walls 12, 14 via tabs 22, forming a substantially closed, rectangular wall extending upward from base 16. Walls 12, 14 further define an opening opposite base 16 and having a size and shape substantially equal to and the same as a size and shape, respectively, of base 16. Engageable surface 30 forms the entire inner surface of folded container 10, while fastening surface 32 forms the entire external surface of folded container 10. In the example of FIG. 2, fastening sides (i.e., provided by surface 32) of tabs 22 are releasably attached to engageable sides (i.e., provided by surface 30) of walls 12. However, in some examples, engageable sides of one or more tabs 22 can alternatively be connected to a fastening side of wall 12 (i.e., one or more tabs 22 may be disposed on external surface 32 of folded container 10).

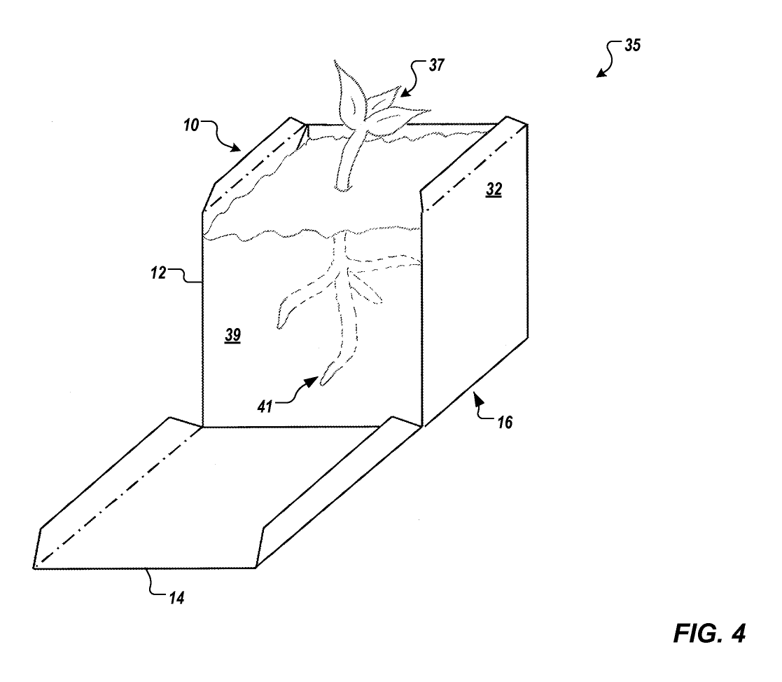

Now referring to FIG. 4, any of walls 12, 14 can be detached from assembled container preform 10 and folded down towards base 16 while the other walls 12, 14 remain attached to one another and folded upward from base 16. A plant system 35 includes a seedling 37 planted in soil 39 within folded container 10. A germination mix may be added to soil 39 to promote germination of seedling 37, which grows roots 41 within soil 39. The roots 41 may grow laterally to contact the inner surface of walls 12, 14. It is believed that such contact may lead to propagation of additional lateral root shoots from the root trunk, and to inhibition of root circling of the soil mass along the container wall. Such root development can help to minimize transplant shock to seedling 37 and roots 41.

In some examples, a gardener may wish to inspect the roots of the seedling in the container to determine their health and maturity. This can be accomplished by detaching any of walls 12, 14 and folding them down toward base 16 in order to expose soil 39 and roots 41. Folding down one or more (or all) of the walls of the container may be helpful for removing the mature seedling with little loss of soil mass and disturbance to the roots. After inspection, the folded down walls 12, 14 may be folded back up and reattached to form a substantially closed wall extending upward from base 16. Upon removing seedling 37, roots 41, and soil 39 from folded container 10, folded container 10 may be unfolded, cleaned, and stored for reuse in a subsequent planting season.

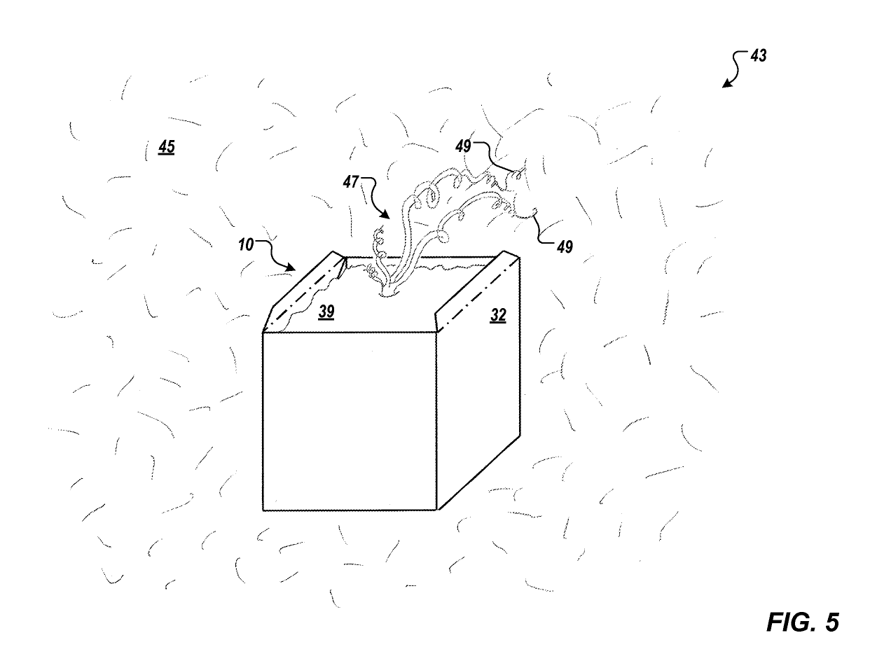

FIG. 5 displays a plant system 43 including an assembled planting container preform 10 releasably attached to a fibrous wall 45 covered with a looped material (e.g., looped material 31) via fastening surface 32. A vine seedling 47 extends from soil 39 within container 10 and has vine tendrils 49 engaged with fibers of wall 45. Generally, fastening surface 32 on any of walls 12, 14 or the underside of base 16 of folded container 10 allows easy attachment of folded container 10 to a supporting fibrous surface.

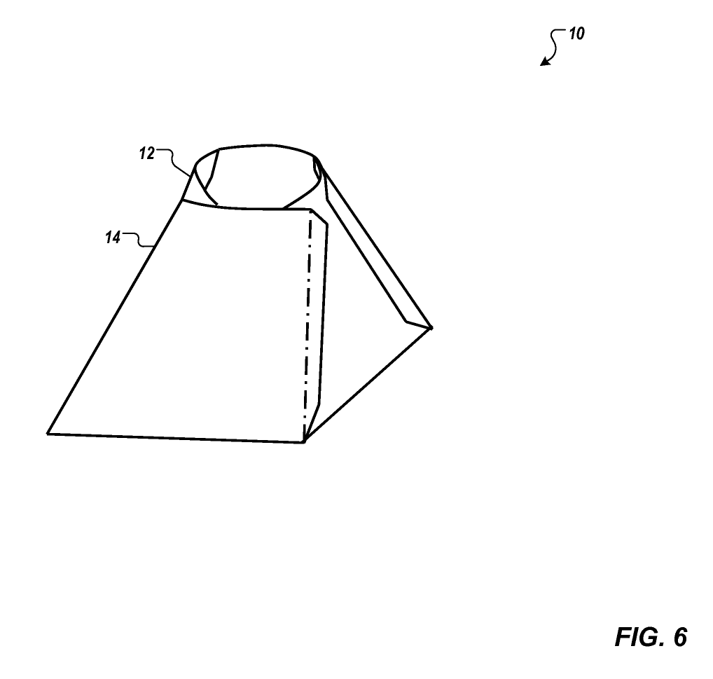

As shown in FIG. 6, foldable container 10 can be assembled such that the size of the opening opposite base 16 is substantially smaller than the size of base 16. For example, this can be achieved by overlapping walls 12 and walls 14 beyond the area provided by tabs 22 to form a non-rectangular (e.g., trapezoidal) shaped wall. In some cases, assembling planting container preform 10 such that the opening is smaller than base 16 provides a plant system whose soil weight is concentrated near base 16 of folded container 10 as opposed to being substantially equally distributed within folded container 10 (e.g., as shown in FIGS. 4 and 5). In some instances, assembling planting container preform 10 such that the opening is smaller than base 16 can guide a direction of seedling growth towards and through the opening from the soil planted within folded container 10.

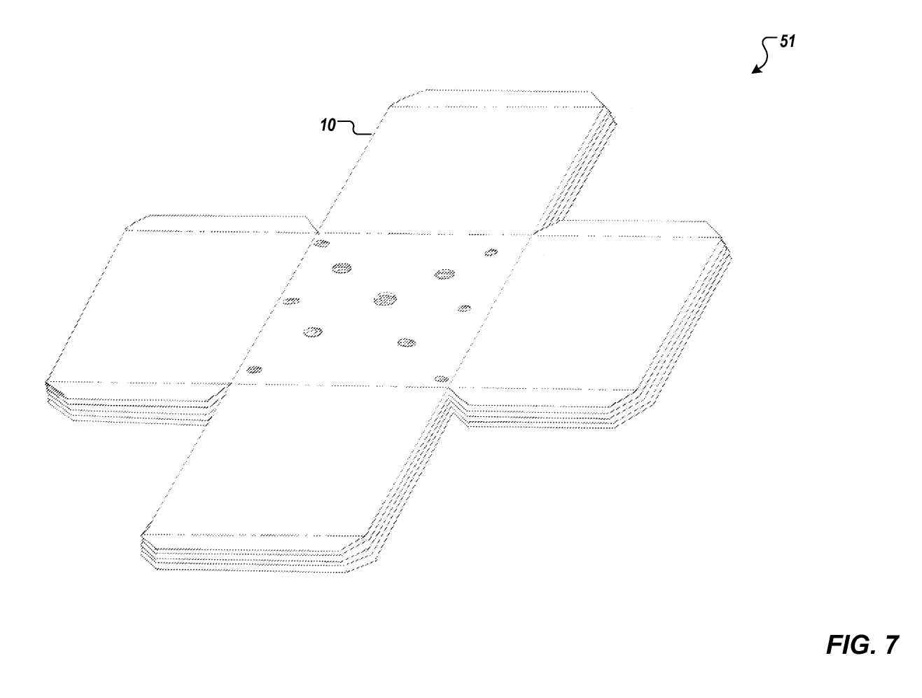

Referring now to FIG. 7, several planting container preforms 10 can be stacked in a disassembled, flat configuration providing a set 51 that can be easily packaged and shipped. For example, in the disassembled, flat configuration, set 51 takes up relatively little space and can therefore be packaged in a thin container or packaged within a flexible, sealed plastic wrap.

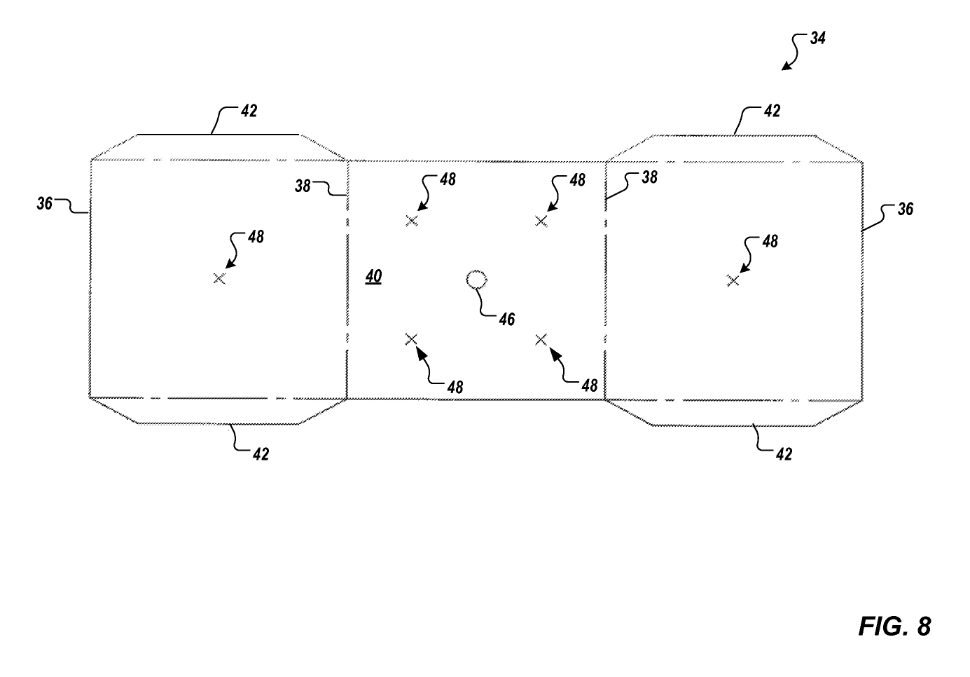

FIG. 8 displays an example view of a partial planting container preform 34 that can be assembled with another partial planting container preform 34 to form a foldable container. Partial preform 34 includes two spaced apart tabbed wall sections 36 extending from opposite, foldable edges of a base section 40. Tabs 42 extend laterally from each side of the wall sections and past base edges 38.

A hole 46 is located at a center of base section 40, and four sets of slits 48 are spaced around hole 46 for drainage. A set of slits 48 is also located at a center of each wall section 36. Partial preform 34 is die-cut from the same material as discussed above with respect to FIG. 1.

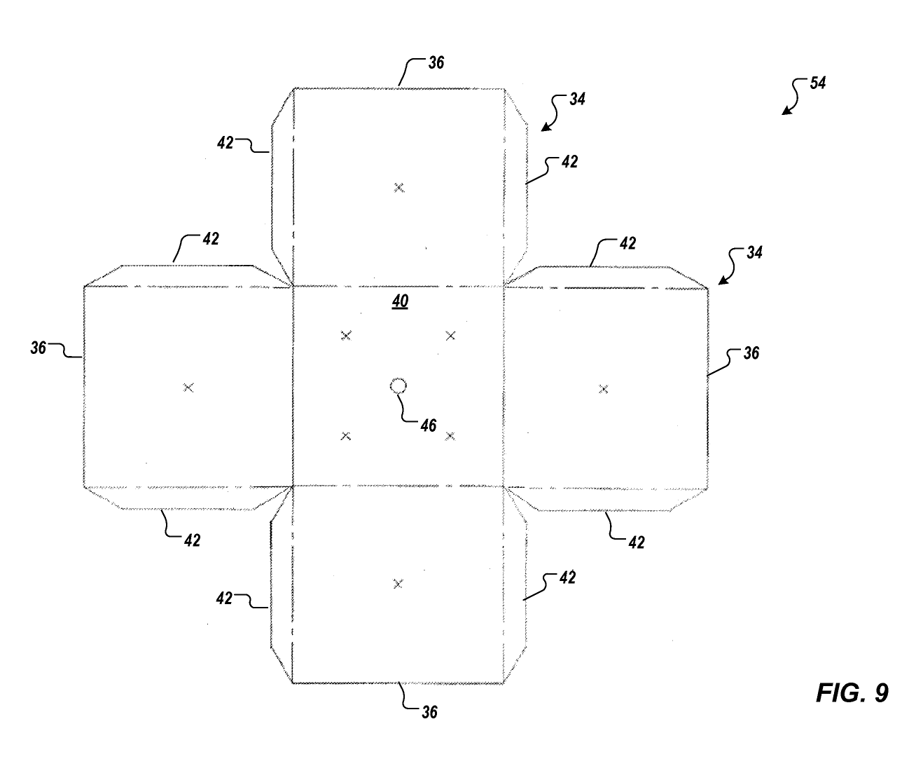

Two such partial preforms 34 may be overlapped in a cross arrangement, such as shown in FIG. 9, to form a container preform 54 that has a shape similar and functionally identical to that of FIG. 1. In this arrangement, the two base sections 40 of the partial preforms 34 are fully aligned and overlapped, with the wall sections 36 extending into different quadrants. Starting from the preform shown in FIG. 9, containers may be fashioned by folding the extending wall sections 36 to form various container shapes, such as those of FIGS. 3 and 6.

For manually transporting such containers, an elongated strip of fastening material may be releasably attached as a handle to the upper portions of the container walls. Such a fastening material may be of the same constructions as the material of the container, with both male and female fastening surfaces, or may be simply a strip of hook tape secured to the fibrous sides of the container walls or a strip of loop material secured to the hook sides of the container walls.

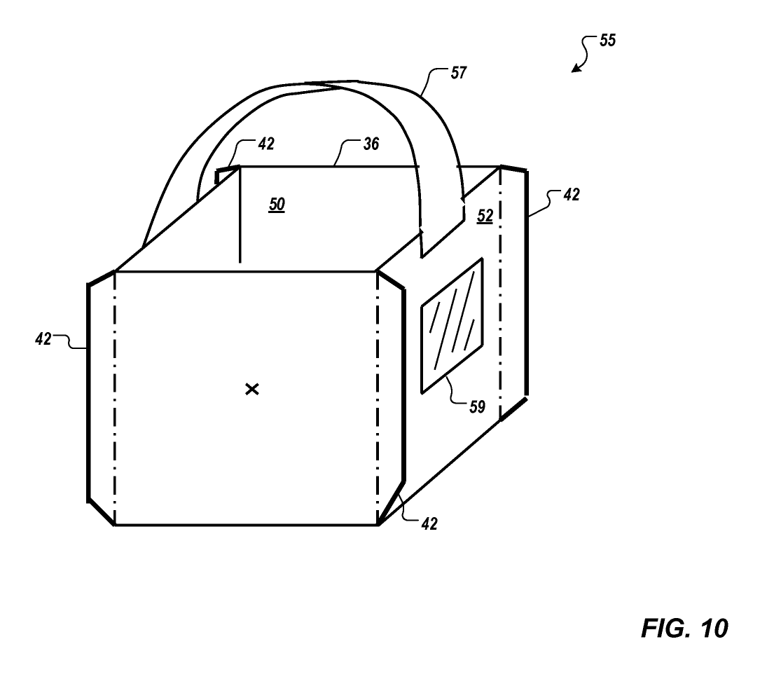

The preforms discussed above may be releasably configured in a number of different planting arrangements. For example, as shown in FIG. 10, a planting container preform 55 is assembled such that tabs 42 extend outward from wall sections 36, forming a substantially closed, rectangular wall extending from base 40. An engageable side of handle 57 is releasably attached to fastening surfaces 52 of opposing wall sections 36. Alternatively, a fastening side of handle 57 can be releasably attached to engageable surfaces 50 of opposing wall sections 36. Folded container 55 further includes a window 59 that allows viewing of soil and seedling roots within the folded container such that a wall section 36 does not need to be detached and folded down from the folded container in order to view the soil and seedling roots. Window 59 can be formed from a clear plastic that, in some cases, is laminated to provide rigidity to the window 59.

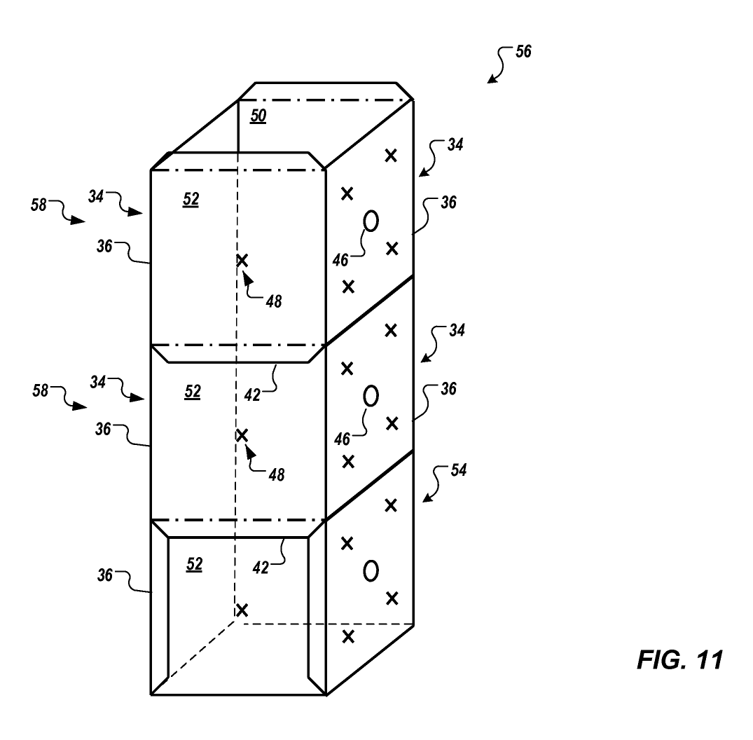

FIG. 11 displays a stacked container 56 forming an elongated potting cavity suitable for tubers or seedlings with deeper root systems. Stacked foldable container 56 includes two upper sections 58 stacked upon one another and upon a base container 54 of similar construction to that of FIG. 2. Each upper section 58 includes two partial preforms 34 of FIG. 5 connected to form a tube, with their wall sections 36 overlapping and their bases 40 on opposite sides of the tube. Tabs 42 extending downward from wall sections 36 within top section 58 attach to adjacent wall sections 36 within bottom section 58. Similarly, tabs 42 extending downward from wall sections 36 within bottom section 58 attach to adjacent wall sections 36 within folded container 54. In the example of FIG. 11, engageable surfaces 50 of tabs 42 are releasably attached to fastening surfaces 52 of wall sections 36. However, fastening surfaces of one or more tabs 42 may alternatively be releasably attached to engageable surfaces 50 of wall sections 36. In some embodiments, a stacked foldable container may include one or several sections 58.

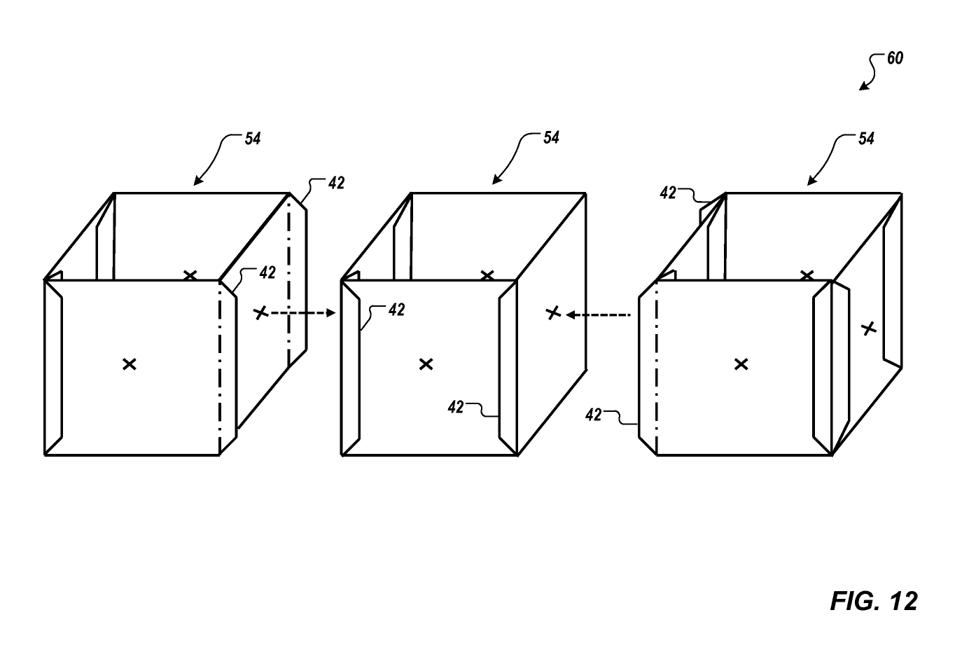

As shown in FIG. 12, two or more foldable containers 54 may be laterally coupled to form a container set 60. In the example of FIG. 9, tabs 42 extending laterally from left and right foldable containers 54 attach to and overlap tabs 42 of a center adjacent foldable container 54, thereby providing container set 60 that includes separate cavities.

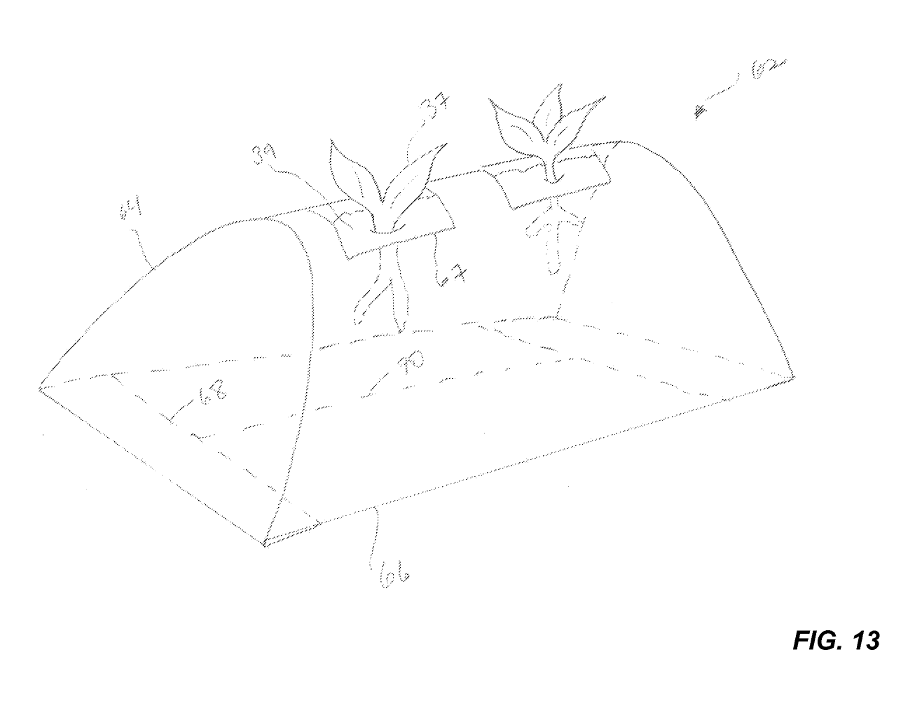

While many of the above examples of planting containers feature four foldable walls, other examples may include a different number of foldable walls. Furthermore, the foldable walls may be of various or differing shapes than those shown. For example, FIG. 13 displays a planting container preform 62 including two end walls 64 and two side walls 66 and assembled at the bottom of folded container 62 via wall sections 68 and wall sections 70 extending from end walls 64 and side walls 66, respectively. Planting container preform 62 also includes one or more openings 67 through which seedlings 37 can grow through from soil 39 encased by folded container 62. Accordingly, folded container 62 is disassembled by peeling the wall sections 68, 70 away from one another at the bottom of the container. The disassembled folded container 62 may be lifted over the seedlings 37 to expose the seedlings 37 and the soil 39.

In some implementations, bending a wall of a foldable container to assemble the container can provide a shape to the container without necessarily producing a crease or a sharp fold in the container preform.

In some embodiments, a cover can be sized to fit over and be included with any of the containers described above. The cover can serve to protect immature seedlings and in some examples. The cover is generally of a light weight construction and, in some instances, includes a clear top, such that a plant within a folded container can be exposed to light while still being covered.

In some embodiments, the above examples of planting containers can include selectively placed fastening surfaces atop larger engageable surfaces or selectively placed engageable surfaces atop larger fastening surfaces (i.e., a reverse mesh configuration). A reverse mesh configuration may be used, for example, to laterally attach one or more containers to one another to form a container set (e.g., to form a container set such as that shown in FIG. 12).

In some instances, the above examples of planting containers can be used as liners that can be inserted within a cavity of a garden pot. In this manner, the garden pot can hold any water drained from soil within a folded planting container, and the folded planting container can be removed from the garden pot to empty the garden pot of excess water or any other undesired particulates remaining in the garden pot once the folded planting container is removed.

In some examples, a planting container preform can include a moisture or pH indicator strip for determining a moisture level or a pH, respectively, of soil within a folded planting container. For example, an indicator strip may be adhered to a fastening surface that allows the indicator strip to be adhered to an engageable surface of a folded container, such that the indicator strip is in contact with the soil but also extends away from the folded container such that the indicator strip is visible.

In some cases, the sheet forming the above examples of foldable containers can be biodegradable, allowing an entire plant system to be planted outdoor within soil without the need to ultimately remove the folded containers from the soil. In some examples, non-woven surfaces of a foldable container can be infused with fertilizer. In some instances, the sheet can be made of a hydroscopic material, such as nylon (e.g., Velcro knit nylon 3905), which functions to absorb water from and release water to a surrounding environment. In this manner, the hydroscopic material can sometimes function as a water wick that transports water from one region of a container to another region of a container.

In some examples, any of the walls extending from the bases of the above described example container preforms can be releasably attached to one another in a manner that allows expansion of a plant beyond edges of the attached walls. For example, folded container 10 can be assembled in a non-rectangular shape such that only end regions of tabs 22 are releasably attached to walls 12. In such a configuration, folded container 12 has a bowed shape with openings between the walls 12, 14, allowing seedling roots to push out against the walls 12, 14 as the seedling matures.

While a number of examples have been described, the foregoing description is not intended to limit the scope of the claimed invention. There are and will be other examples and modifications within the scope of the following claims.

What is claimed is:

1. A method of preparing a container for planting, the method comprising:
bending a flexible sheet of material into an overlapped configuration to form a container defining an interior volume for holding soil, the flexible sheet having a first broad surface covered with an engageable loop material exposed over at least half of an interior surface area of the container, and a second broad surface from which touch fastener hooks extend in an area overlapping the first broad surface with the sheet of material folded to form the container, with the touch fastener hooks releasably engaged with the engageable loop material; and
placing the soil in the interior volume of the container, in contact with the loop material.

2. The method of claim 1, wherein the touch fastener hooks extend in an array covering a majority of an outer surface area of the container.

3. The method of claim 1, wherein the loop material essentially covers the interior surface area of the container.

4. The method of claim 1, wherein the loop material is a knit or non-woven material.

5. The method of claim 1, wherein the loop material has a basis weight of between 40 and 400 grams per square meter.

6. The method of claim 1, wherein the loop material comprises hydroscopic fibers.

7. The method of claim 1, wherein the second broad surface is disposed on an outer surface of the container.

8. The method of claim 1, wherein both the first and second broad surfaces are disposed on an inner surface of the formed container.

9. The method of claim 1, wherein the flexible sheet of material comprises a continuous sheet of resin from which the touch fastener hooks extend on the second broad surface, the sheet of resin and stems of the touch fastener hooks together forming a contiguous mass of resin.

10. The method of claim 9, wherein the loop material and the continuous sheet of resin form a laminate in which some fibers of the loop material are at least partially embedded in the continuous sheet of resin, with other fibers exposed for engagement.

11. The method of claim 1, wherein, as bent, the flexible sheet forms the container having a base and defining a plant growth opening opposite the base, the plant growth opening being smaller than the base.

12. The method of claim 11, wherein an outer surface of the base is covered by the touch fastener hooks.

13. The method of claim 1, wherein the flexible sheet of material is shaped to define flaps extending from a central portion of the sheet of material, and wherein bending the flexible sheet of material comprises bending the flaps to form respective sides of the container.

14. The method of claim 1, wherein the method further comprises, prior to bending the flexible sheet of material, overlapping two separate flexible pieces of material to form the flexible sheet of material, the two pieces of material each having a loop material on one side and a field of engageable fastener hooks on the other side, such that the hooks of one of the two pieces releasably engage loops of the other of the two pieces.

15. The method of claim 14, wherein each of the pieces of material forms a pair of oppositely-directed flaps of the flexible sheet of material.

16. The method of claim 14, wherein the container as formed has a first wall with an interior surface covered with loops, and an adjacent wall with an interior surface covered with touch fastener hooks and releasably secured to the first wall by overlapping wall tabs extending outward from the container between the first and adjacent walls.

17. The method of claim 1, the method further comprising forming multiple container portions, each defining a respective interior planting volume, one of the container portions having an outer surface carrying exposed touch fastener hooks, and another of the container portions having an outer surface covered with an engageable loop material, and then releasably engaging the container portions to form a connected container defining multiple planting volumes.

18. The method of claim 1, the method further comprising overlapping and releasably attaching a container extension about a rim of the container formed by the sheet of material, thereby increasing a planting volume of the container.

19. A convertible planting system, comprising:
a flexible sheet of material bent into an overlapped configuration to form a container defining an interior volume, the flexible sheet having a first broad surface covered with an engageable loop material exposed over at least half of an interior surface area of the container, and a second broad surface from which touch fastener hooks extend in an area overlapping the first broad surface with the sheet of material bent to form the container, with the hooks releasably engaged with the loop material; and
soil filling at least a portion of the interior volume of the container and in contact with the loop material.

20. A method of preparing a seedling for transplant, the method comprising:
planting a seed in the convertible planting system of claim 19;
growing a seedling from the seed, such that roots of the seedling contact the engageable loop material of the interior surface of the container;
peeling back a portion of the sheet of material forming a wall of the container by releasably disengaging hooks and loops of the sheet of material, to expose the soil and an adjacent root of the seedling; and then
reattaching the portion of the sheet of material by reengaging the hooks and loops that were disengaged.
